(19) United States
(12) Patent Application Publication
(10) Pub. No.: US 2005/0015442 A1
(43) Pub. Date: Jan. 20, 2005

(54) Page views for proxy servers

(76) Inventors: Eric O'Laughlen, Aldie, VA (US); Sudheer Agrawal, Ashburn, VA (US); John Robinson, South Riding, VA (US)

Correspondence Address: FISH & RICHARDSON P.C., 1425 K STREET, N.W., 11TH FLOOR, WASHINGTON, DC, 20005-3500, US

(21) Appl. No.: 10/747,265

(22) Filed: Dec. 30, 2003

Related U.S. Application Data
(60) Provisional application No. 60/474,623, filed on Jun. 2, 2003.

(51) Int. Cl. G06F 15/16; G06F 15/173

(52) U.S. Cl. 709/203; 709/226; 709/219

(57) ABSTRACT

A page view field is included in an HTTP request that contains a requested URL and indicates the URL for the web page or other document from which the requested URL was obtained (either directly or indirectly). A browser may add the page view field to an HTTP request whenever the requested URL is obtained from within a web page or other document displayed in browser. This field may be used by a proxy or other server to perform processing related to a number of applications. The processing may relate to access controls, e.g., parentally controlled accounts. For example, the applications may include the reporting of URLs visited by parentally controlled accounts; or allowing parentally controlled accounts to access lower level web pages of web pages the account has been given permission to access. Also, the processing may relate to accurately tracking frequently requested resources such as web pages.

### CLAIM OF PRIORITY

This application claims priority under 35 USC §119(e) to U.S. Provisional Patent Application Ser. No. 60/474,623, filed on Jun. 2, 2003, the entire contents of which are hereby incorporated by reference.

### TECHNICAL FIELD

This description relates to proxy server processing.

### BACKGROUND

Client computers can communicate with a server to remotely access information stored at the server. The transfer of information between the server and client computers may be provided by observing standard protocols and using software applications. For example, a hypertext markup language (HTML) browser application at a client computer can communicate over the public Internet using standard communication protocols, such as TCP/IP and hypertext transfer protocols (HTTP), to retrieve resources such as web pages or objects from a HTTP server. Web pages may include formatted text as well as objects, such as multimedia elements including, for example, embedded graphics, sounds, and/or video. Exemplary browser applications include Netscape Navigator and Microsoft Internet Explorer.

The America Online (AOL) client is an example of a proprietary browser application. The AOL client executes on a client computer connected to the AOL network. To receive web pages from servers on the AOL network, the AOL client communicates with servers on the AOL network using proprietary communication protocols. When the AOL client seeks to receive web pages available on HTTP servers located on the public Internet, the AOL client communicates with a proxy server on the AOL network. The proxy server then communicates with HTTP servers on the public Internet using standard communication protocols, such as TCP/IP and HTTP, to receive the web pages from the HTTP servers. The web pages received from HTTP servers may be written in a standard language such as HTML, while the AOL client renders web pages written in a proprietary language. Thus, once received, the proxy server translates the web pages, as necessary, into the proprietary language and forwards the translated web pages to the AOL client.

### SUMMARY

In one aspect, techniques for processing a request for a first resource located on a server computer are described. The request for the first resource is received from a client computer and indicates a location of the first resource. A determination is made as to whether the received request indicates that the location of the first resource was obtained from a second resource rendered at the client computer. Processing related to access controls is performed based on whether the received request indicates that the location of the first resource was obtained from a second resource rendered at the client computer.

Implementations of this aspect may include one or more of the following features. For example, the second resource rendered at the client computer may be a document displayed by a browser at the client computer.

The access controls relate to a parental control service. Generally, performing processing related to access controls may comprise including the location of the first resource in a report to a parental account when the request does not indicate that the location of the first resource was obtained from a second resource rendered at the client computer and/or excluding the location of the first resource from a report to the parental account when the request indicates that the location of the first resource was obtained from a second resource rendered at the client computer.

When the second resource is a document displayed by a browser, whether a location is included or excluded in a report may be performed based on whether the request indicates the location of the first resource was obtained as a result of a user selecting a hyperlink to the first resource or as a result of the browser displaying the document.

The request may further indicate a location of the second resource from which the location of the first resource was obtained and performing processing related to access controls comprises may include using the location of the second resource to determine if a parentally controlled account is permitted to obtain the second resource; and providing the first resource to the client computer when the parentally controlled account is permitted to obtain the second resource.

Performing processing related to access controls comprises may include providing the client computer with the first resource when the request indicates that the location of the first resource was obtained from a second resource rendered at the client computer.

When the request does not indicate that the location of the first resource was obtained from a second resource rendered at the client computer, a determination may be made as to whether a parentally controlled account is permitted to obtain the first resource. The client computer may be provided with the first resource when the parentally controlled account is permitted to obtain the first resource.

The techniques may be performed at a proxy server. The request may be modified by removing the indication that the location of the first resource was obtained from a second resource rendered at the client computer and the modified request may be sent to the server computer. A response may be received from the server computer and forwarded to the client computer.

In another aspect, a request for a first resource is received from a client computer and indicates a location of the first resource. A determination is made as to whether the received request indicates that the location of the first resource was obtained from a second resource rendered at the client computer. Processing related to accurately tracking frequently requested resources is performed based on whether the received request indicates that the location of the first resource was obtained from a second resource rendered at the client computer.

Implementations of this aspect may include one or more of the following features. For example, the second resource rendered at the client computer may be a document displayed by a browser at the client computer. Performing processing related to accurately tracking frequently requested resources may include incrementing a count associated with the first resource when the request does not indicate that the location of the first resource was obtained from a second resource rendered at the client computer. The first resource may be ranked with other requested resources based on the count. A defined number of resources that are highly ranked may be selected. The location of the selected resources may be provided to the client computer such that the browser can display a document that includes hyperlinks to the selected resources.

Performing processing related to accurately tracking frequently requested resources may include determining if the location of the first resource has been stored previously when the request does not indicate that the location of the first resource was obtained from a second resource rendered at the client computer; storing the location of the resource when the location of the resource has not been stored previously; and associating a count with the stored location.

In another aspect, a request for a resource is received from a client computer and indicates a location of the resource. A determination is made as to whether a field in the received request indicates the location of the first resource was obtained from a document displayed by a browser at the client computer. A list that contains locations of resources requested by the browser at the client computer is generated. The location of the resource is excluded from the list when a field in the received request indicates the location of the first resource was obtained from a document displayed by a browser at the client computer.

Implementations of the described techniques may include hardware, a method or process, or computer software on a computer-accessible medium.

The details of one or more implementations are set forth in the accompanying drawings and the description below. Other features will be apparent from the description and drawings, and from the claims.

### DESCRIPTION OF DRAWINGS

FIG. 1 is a diagram showing a network that includes server computers and client computers.

FIG. 2A is an illustration showing a web browser and displayed web page.

FIG. 2B is a portion of the source code for the web page shown in FIG. 2A.

FIGS. 3A-3C show various HTTP requests related to the web page shown in FIG. 2A.

FIG. 4 is a flowchart showing a process that occurs when a web browser requests a web page.

FIG. 5 is a flowchart that shows an implementation of proxy server processing.

FIG. 6A is a flowchart that shows an implementation of proxy server processing.

FIG. 6B is a diagram that shows a relationship between multiple URLs for web pages.

FIG. 7 is a flowchart that shows an implementation of proxy server processing.

### DETAILED DESCRIPTION

Generally, a page view field is included in an HTTP request that contains a requested URL. The page view field includes a header and data that indicates the URL for the web page or other document from which the requested URL was obtained (either directly or indirectly). A browser may add the page view field to an HTTP request whenever the requested URL is obtained from within a web page or other document displayed in browser.

This field may be used by a proxy or other server to perform processing related to a number of applications. The processing may relate to access controls, e.g., parentally controlled accounts. For example, the applications may include the reporting of URLs visited by parentally controlled accounts; or allowing parentally controlled accounts to access lower level web pages of web pages the account has been given permission to access. Also, the processing may relate to accurately tracking frequently requested resources such as web pages.

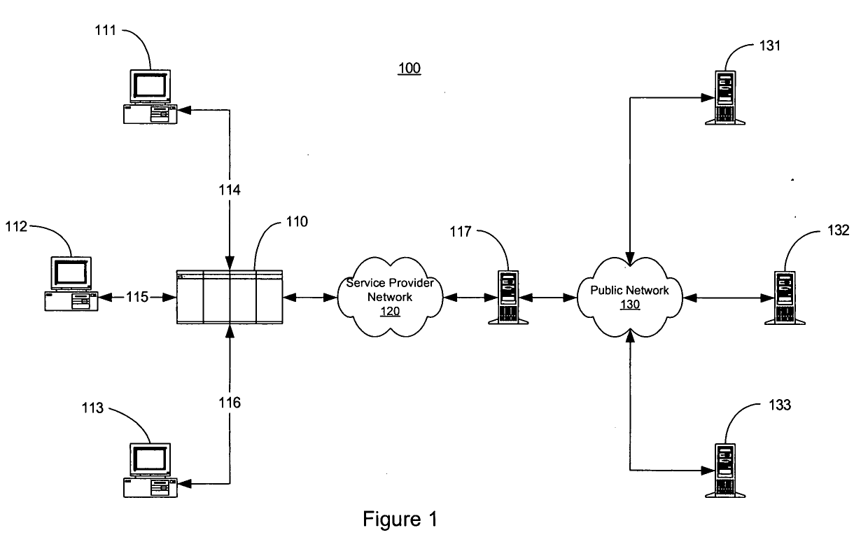

FIG. 1 shows a network 100 that includes server computers 131-133 and client computers 111-113. Server computers 131-133 may execute hypertext transfer protocol (HTTP) server software to respond to data requests from HTTP-based web browsers executing at client computers 111-113. Client computers 111-113 can send HTTP data requests to servers 131-133 over data paths that include access connections 114-116, a service provider's point of presence (POP) 110, network 120, proxy server 117, and a public network 130. The HTTP data requests can target various types of resources such as documents (e.g., web pages) or objects (e.g., executable files, audio files, or video files). The service provider's POP 110 includes data communications equipment that enables and regulates communication between client computers 111-113 and the service provider's network 120. For example, POP 110 may include dial-up modem banks, cable modem banks, wireless communications equipment, or other data transmission equipment.

Access to a service provider's POP 110 may be restricted to certain users of the client computers 111-113. To enforce access restrictions, POP 110 may implement security and authentication mechanisms such as login verification. A login verification mechanism may require a user to input a valid user name and password to obtain access to the service provider's network 120. If the user name and password are invalid, the user may be disconnected. Security and authentication mechanisms also may be implemented at a separate login server (not shown) connected to the service provider's network 120 and/or POP 110.

After a valid connection has been established between a client computer and POP 110, data may be exchanged between software applications running on the client computer, and applications running on other computers on the service provider's network 120. The service provider's network 120 may be interconnected with another network 130 by a proxy server 117 that can exchange data between the service provider's network 120 and computers on another network 130.

Proxy server 117 can function as a surrogate for another computer. For example, proxy server 117 may receive HTTP data requests directed to HTTP server software at one of the server computers 131-133 from a browser application at client computer 111. When the proxy server 117 receives a data request, it may attempt to fulfill the data request using data stored at a local database or hard disk (not shown). If the proxy server 117 has the needed data, the data can be returned to the client computer 111 without requiring further interaction with servers 131-133. If the proxy server 117 is unable to fulfill the request, it may forward the request to the appropriate one of the servers 131-133, receive a response from that server, and send the response to the client computer 111. Proxy server 117 may perform some processing on the response before sending it to client computer 111.

The proxy server 117 also may store response data on a hard disk drive or local database for future use. Networks 120 and 130 also may be interconnected by a gateway, bridge, router, or other interconnection device instead of, or in addition to, proxy server 117.

While the foregoing has described the various components of network 100 as using the HTTP protocol, other standard or proprietary communication protocols may alternatively be used. In another implementation, for example, proprietary browsing software may execute on client computers 111-113 and may communicate with other computers (including proxy computer 117) on service provider network 120 using proprietary protocols, or a mix of standard and proprietary protocols. Proxy server 117 interfaces service provider network with public network 130 by translating requests and responses from the proprietary protocol into the standard protocols. Additionally, if the browser executing on client computer 111 only renders web pages written in a proprietary language and a web page written in a standard language is retrieved from a server 131-133, proxy server 117 may convert the standard language web page into a proprietary language web page.

Thus, in this exemplary implementation, client computers 111-113 execute the proprietary browsing software and communicate with proxy server 117 using the proprietary communications protocol. Proxy server 117 then communicates with servers 131-133 using the standard protocol to receive the requested web page. Proxy server 117 translates the web page as necessary and forwards the web page to the appropriate one of the client computers 111-113 using the proprietary communications protocol.

In other implementations, public network 130 may use other standard or proprietary communication protocols and web pages may be written in other standard or proprietary languages. In general, the standard or proprietary protocol or language used on public network 130 may be the same or different than the standard or proprietary protocol or language used on service provider network 120.

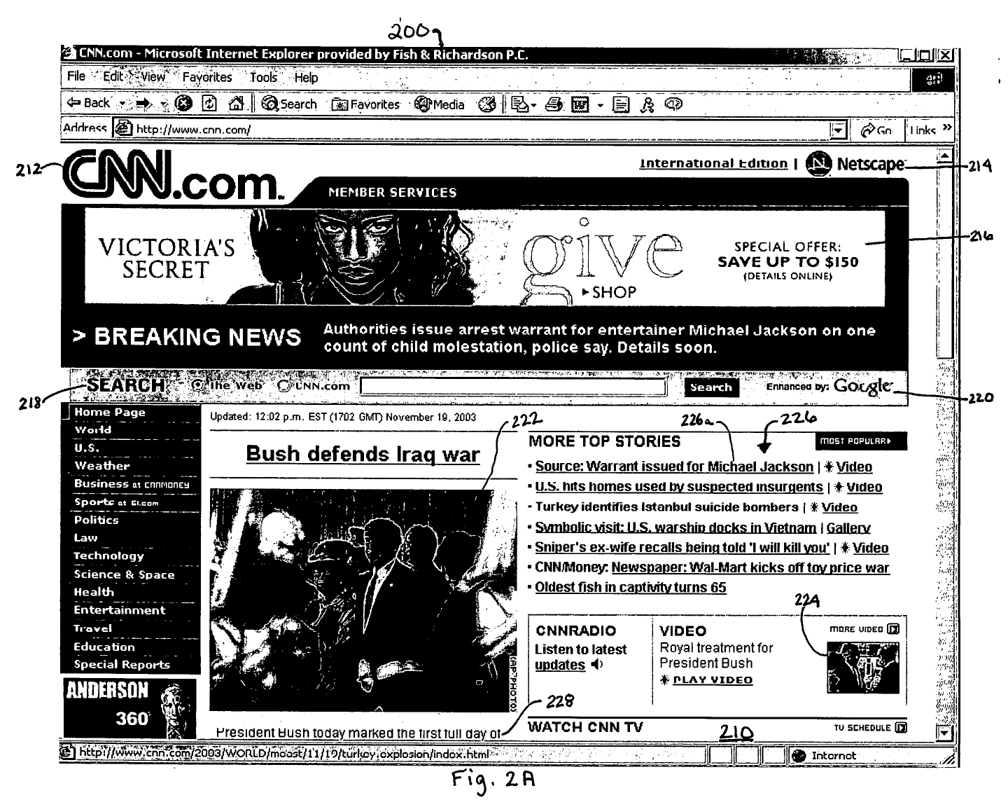

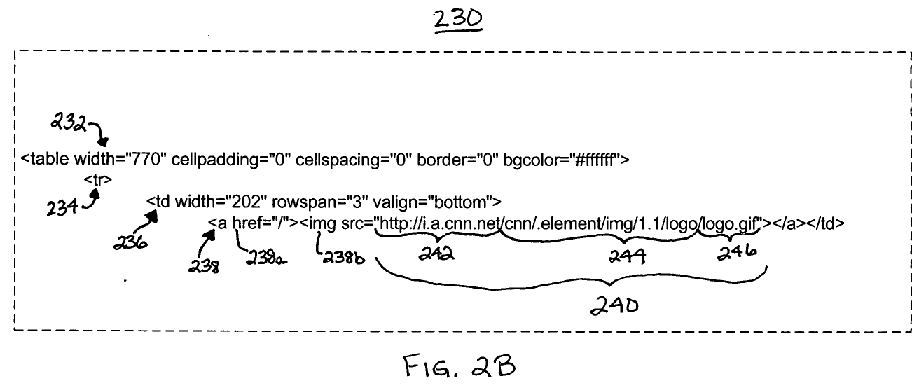

FIG. 2A shows a web browser 200 display of a web page 210. The term web page as used herein refers generally to documents displayed by a browser, whether those documents are written in a standard or proprietary language.

Web page 210 is the default web page for the domain www.cnn.com. After proxy server 117 has sent web page 210 to, e.g., client computer 111 (either from the proxy server's local hard drive or database or from a server 131-133), web browser 200 renders the web page 210 so that a user of client computer 111 can view it. Web page 210 is composed of text, hyperlinks and a number of objects such as embedded graphics. For example, web page 210 includes graphics 212-224, hyperlinks 226, and text 228. While not shown, the objects can also include, for example, audio files, video files, executable files, or other resources.

Web pages are typically text files written in a standard or proprietary language that is understood by browser 200. Some standard languages include HTML and the extended mark-up language (XML). The text file (otherwise referred to as the web page source code) constitutes instructions to the web browser 200 as to what the browser should display when it renders the web page. The web browser 200 processes the source code (e.g., a HTML text document) and renders the web page 210 to the user accordingly.

Because web pages are normally text files, they typically contain text and hyperlinks. By contrast, graphics typically need to be retrieved when browser 200 renders a web page. The web page source code includes instructions that direct browser 200 to the location of the graphics to be loaded (typically located on the server that provided the web page source code). Browser 200 uses the instructions to retrieve the graphics when browser 200 renders the web page.

FIG. 2B shows a portion of source code 230 that corresponds to web page 210. The source code for web page 210 is written in HTML. HTML consists of text “tags” that provide browser 200 with certain information and instruct the browser 200 how to display that information. A tag is text surrounded by the brackets “<>.” In the example provided by source code 230, tags 232-236 primarily instruct browser 200 as to where browser 200 is to display graphic 212. Tags 238a and 238b instruct browser 200 to display graphic 212 and to hyperlink the graphic 212 to a particular web page (in this case, graphic 212 is hyperlinked to web page 210). The anchor tag 238a, <a>, instructs the browser to create the hyperlink. The image tag 238b, <img>, instructs the browser to insert graphic 212. Image tag 238b includes the location of graphic 212 as an argument. The location of the graphic 212 is expressed as a Uniform Resource Locator (URL) 240.

URL 240 includes several sections that identify the location of graphic 212. A first section 242 indicates that graphic 212 is located at a server whose domain name is “i.a.cnn.net.” First section 242 also indicates that graphic 212 is available at the server via the HTTP protocol. A second section 244 indicates the directory location of graphic 212 on the server. A third section 246 indicates the filename of graphic 212, namely, “logo.gif.”

Using the URL 240 and the domain name system (DNS), web browser 200 can determine the address of the server computer (e.g., server computer 131) that stores graphic 212, along with the location of graphic 212 on the server computer 131. With this information, web browser 200 can retrieve graphic 212 from server computer 131 and display graphic 212 appropriately.

More specifically, when browser 200 is rendering web page 210, browser 200 processes image tag 238b by first contacting a DNS server (not shown) to obtain the address of the server whose domain name is “i.a.cnn.net” (e.g., server computer 131). Next, browser 200 causes client computer 111 to send a request for graphic 212 to server computer 131, which is first received by proxy server 117. Proxy server 117 may perform some processing as a result of receiving the request (further described below). Proxy server 117 then forwards the request for graphic 212 to the server computer 131, receives graphic 212 from server computer 131, and forwards graphic 212 back to client computer 111 so that browser 200 can display graphic 212.

Other implementations of the steps used to obtain web pages or other information from servers 131-133 are possible, and may depend on the particular protocols used by client computers 111-113, proxy server 117, and severs 131-133.

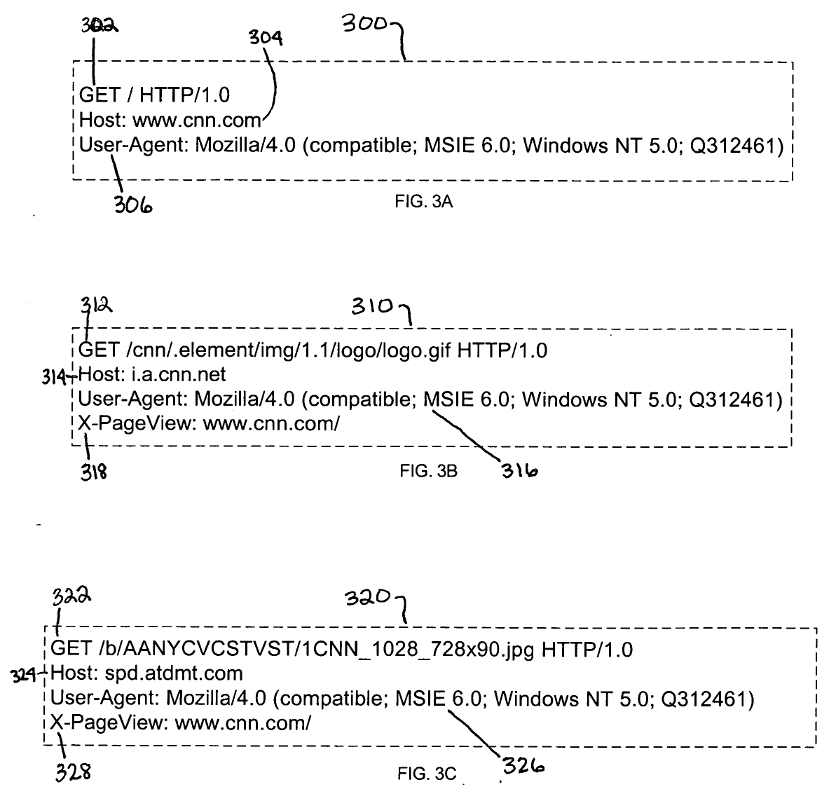

FIG. 3A shows an HTTP request 300. In an HTTP implementation, an HTTP request 300 is sent by client computer 111 to proxy server 117. HTTP request 300 includes a structured sequence of fields 302-306. Each field 302-306 includes an HTTP header and data associated with the header. For example, field 302 includes the header “GET,” which indicates that the HTTP request is a “GET” request to obtain a default web page located at the top-level of the directory structure (indicate by data “/”) at the server. In field 304, header “Host:” indicates the server computer from which the default web page is to be obtained. In request 300, the server is the server whose domain is “www.cnn.com.” Field 306 includes the HTTP header “User-Agent:.” The data of field 306 is “Mozilla/4.0 (compatible; MSIE 6.0; Windows NT 5.0; Q312461),” which designates the type of browser generating the request 300.

In addition, HTTP requests are sent to proxy server 117 to retrieve the objects, such as graphics 312-324, included in web page 210 when the browser renders the web page. For example, FIGS. 3B and 3C show the HTTP requests 310 and 320 for graphics 212 and 216, respectively. Request 310 has fields 312-318 and request 320 has fields 322-326. Fields 312-316 and 322-326 are similar to fields 302-306 of request 300. For example, field 312 indicates that the request is a GET request to obtain graphic 212 and includes the filename and location of graphic 212 on the server, namely, “/cnn/.element/img/1.1/logo/logo.gif.” Field 314 indicates the graphic 212 is located on the server whose domain name is “i.a.cnn.net” and field 316 indicates the type of browser making the request.

Each of requests 310 and 320 also include an additional field 318 and 328 (the page view field), respectively. This field includes a header and data that indicates the URL for the web page or other document from which the requested URL was obtained. For example, in request 310, field 318 includes the header “X-PageView:” that has as its data “www.cnn.com/.” The data is “www.cnn.com/” because requested URL 240 (which points to graphic 212) was obtained from the default web page 210 on www.cnn.com and the default web page 210 for www.cnn.com has the URL “www.cnn.com/.” Browser 200 obtained requested URL 240 for graphic 212 from this default web page 210 when the browser 200 was rendering web page 210. Similarly, field 328 includes the header “X-PageView:” that has as its data “www.cnn.com/.”

As can be seen by comparing requests 310 and 320, some objects on web pages are not from the same servers, or even from the same domain. For example, referring to fields 314 and 326, graphic 212 is located on the server with the domain “i.a.cnn.net,” while the graphic 216 is located on the server with the domain “spd.atdmt.com.”

As described above, HTTP requests 300, 310 and, 320 may be sent from a client computer 111 to proxy 117 and forwarded through the proxy 117 for delivery to a server computer 131. As further described below, the page view field in requests 310 and 320 allow proxy server 117 to perform processing based on a page view (as described below) of a web page 210 as an alternative, or in addition to, an object view of the web page, as opposed to simply being able to perform processing on an object view.

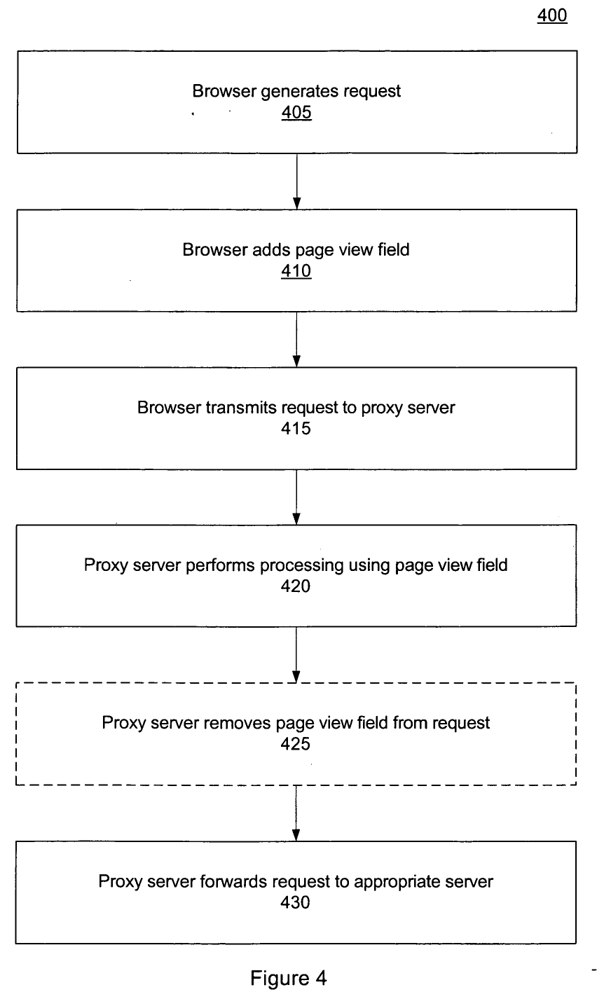

Referring to FIG. 4, when a page view field is used, web browser 200 generates a request (405) and adds the page view field to the request (410), if appropriate. Browser 200 typically adds the page view field whenever the URL for the information being requested is obtained from within a web page or other document displayed in browser 200. Thus, for example, the page view field is added when the browser is rendering a web page and needs to retrieve an object for display in the page, or, for example, when a user selects a hyperlink in a web page.

The URL for the information being requested may be obtained directly from within the web page or other document being displayed, or indirectly, for example, as a result of a HTTP redirect. For instance, a URL in a web page may point to a redirecting resource that returns the URL to a graphic that is to be displayed in the web page. Browser 200 may track that the URL to the graphic is obtained (although indirectly) from the URL in the web page. Browser then includes the URL for the web page in the page view field that is part of the request for the graphic, instead of the URL to the redirecting resource from which the URL for the graphic was directly obtained.

The request then is transmitted to proxy server 117 (415), which performs processing using the page view field (420). The page view field allows proxy server 117 to have a page view of the requests received by proxy server 117, thus providing proxy server 117 with information about the existence (or lack thereof) and location/identification of a web page containing the requested URL. This allows proxy server 117 to perform processing based on the fact that the requested URL (or object pointed to by the requested URL) is part of a web page and which web page the requested URL (or object pointed to by the requested URL) is a part of. Proxy server 117 also may perform processing based on the object view of the requests. An object view refers to the information that the proxy server has about the URL itself or information about the object itself pointed to by the URL, without regard to the relationship between the URL or object and other web pages.

The proxy server processing may relate to a number of different applications. As described below, the processing may relate to parentally controlled accounts. For example, the applications may include the reporting of URLs visited by parentally controlled accounts; or allowing parentally controlled accounts to access lower level web pages of web pages the account has been given permission to access. Also as described below, the processing may relate to accurately tracking frequently requested resources such as web pages.

Proxy server 117 optionally removes the page view field from the request (425) if it is included, and forwards the request to the appropriate server computer 131-133 (430). Because the page view field is not a standard field servers do not use this field, and therefore, removing it does not effect server processing of the request. The appropriate server computer 131-133 processes the request, as normal, and returns a reply to proxy server 117, which forwards the reply to the appropriate client computer 111-113.

As described, proxy server processing may relate to the reporting of URLs visited by parentally controlled accounts. Some Internet Service Providers (ISPs) provide parents with the ability to create accounts that are parentally controlled, i.e., have certain permissions set by the parents. As part of the parental control service, an ISP may wish to provide an indication of the URLs visited by the parentally controlled account and report the URLs to a parental or supervisory account, for example, by sending an e-mail to the parental account with a list of the URLs visited; by presenting a dialog box to a user of the parental account with a list of the URLs; or by presenting a web page to the user of the parental account with a list of the URLs. The user of the parental or supervisory account, or of the parentally controlled account, may be a child, a parent or supervisor, or both.

The proxy server 117 may use the page view field to more accurately show which URLs were retrieved intentionally by the user of the parentally controlled account. With the page view field, proxy server 117 can determine that the requested URL was obtained from the web page when the web page was displayed to the user. To help prevent confusion on the part of the parents, proxy server 117 may exclude the URLs obtained from the web page. That is, to avoid misleading a parent with an indication, for example, that the user of the parentally controlled account intentionally visited a default web page and all of the objects (e.g., graphics) displayed, embedded, or otherwise called because of the default web page, the web page view may be used to distinguish or filter web pages called as a result of an accessed web page being rendered.

For example, if the user of the parentally controlled account retrieves the default web page at www.cnn.com/, proxy server 117 stores this URL when HTTP request 300 is received from, e.g., client computer 111. As web browser 200 is rendering web page 210, proxy server 117 also receives HTTP requests 310 and 320. Without the page view field, proxy server 117 may be unable to determine that the URLs in requests 310 and 320 are being requested as a result of web page 210 being rendered, thus proxy server 117 may store each URL and generate a reporting list for the parents that includes:
www.cnn.com/
i.a.cnn.net/cnn/.element/img/1.1/logo/logo.gif
spd.atdmt.com/b/AANYCVCSTVST/1CNN_{—}1028_{—}728×90.jpg
   While it is possible that the parents may be able to guess that the second URL resulted from the user's visit to the web page at www.cnn.com/ (because the URLs include similar domains, namely, cnn.com and cnn.net), they will be burdened to do so. Furthermore, it is likely difficult for the parents to determine that the third URL was requested as a result of the user visiting www.cnn.com/. Thus, the parents may falsely believe that the user intentionally visited the third URL, when in fact the URL is listed because the user visited www.cnn.com/. This may lead parents to believe their children are visiting many more sites than the children actually are, or visiting sites that the parents potentially may not approve of.

By using the page view header, however, proxy server 117 can determine that the second and third URLs were obtained from within web page 210 (at www.cnn.com/). As a result, proxy server may exclude these URLs from the list reported to the parents.

To differentiate between URLs retrieved when rendering a web page and URLs retrieved when a user selects a hyperlink in the web page, the page view header may have an additional data item that indicates whether the URL is one selected by the user or is one that is retrieved while rendering a web page. In such an implementation, proxy server 117 may exclude those URLs that are contained in a web page and retrieved as a result of the web page rendering, but include in the reporting list those URLs that are contained in a web page as hyperlinks and selected by the user. This may be useful because parents, for example, may be interested in the web pages the user of the parentally controlled account is intentionally visiting (e.g., by selecting a hyperlink or by typing a URL into the web browser 200). But at the same time, the parents may not want to know the URLs of the objects displayed in the intentionally visited web pages, or may be confused by those additional URLs being included, as described above. Thus, for example, it may be desirable to exclude the URL for graphic 212 from the list, but include the URL for a hyperlink 226 if the user selects the hyperlink.

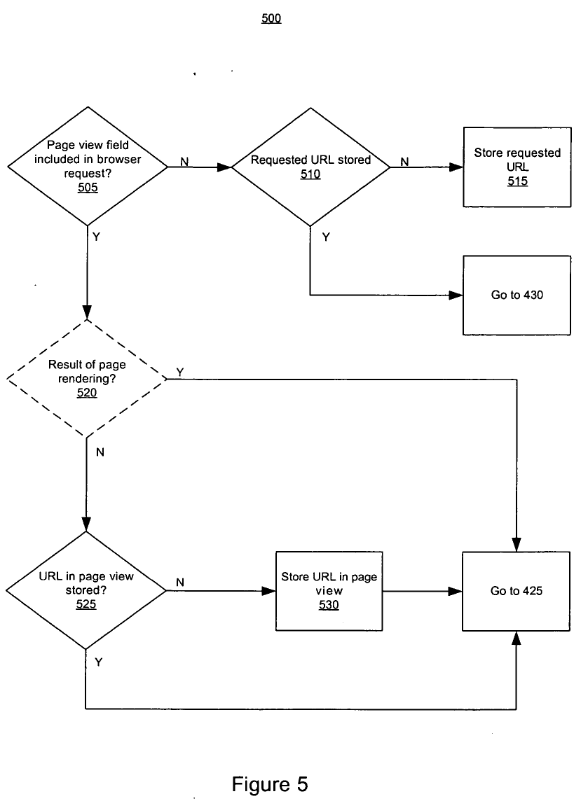

Referring to FIG. 5, in such an application, the processing based on the page view header (420) may include determining if a page view field is included in the received request (505). If the page view field is not included in the request (505), then the requested URL is the one requested by the user (e.g., by clicking on a hyperlink or typing the URL into an address bar of the browser). Thus, if the page view field is not included in the request (505), the requested URL in the request is stored for reporting (515), if the URL has not been stored previously (510). If the requested URL has been stored previously (510), then proxy server 117 forwards the request (430).

If the page view field is included in the received request (505), a determination is made as to whether the URL contained in the data of the page view field has been stored for inclusion in the list (525). If not, the URL contained in the data of the page view field is stored (530) and proxy server 117 moves on to removing the page view field (425). If the URL in the data of the page view field has already been stored (525), then proxy server 117 moves on to removing the page view field (425).

Optionally, if the page view field has additional data indicating whether the URL was retrieved as a result of being user-selected selected or as a result of rendering a user-selected web page, then proxy server 117 may determine whether the request is a result of the page rendering (520) before determining if the URL in the data of the page view has previously been stored (525). That is, proxy server may determine whether the requested URL is being retrieved as a result of rendering or as a result of the user selecting a hyperlink for the requested URL (520). If the requested URL is being retrieved based on the user selecting a hyperlink (520), then proxy server 117 continues the previous processing by determining whether the URL contained in the data of the page view field has been stored for inclusion in the list (525). If, on the other hand, the requested URL is being retrieved as a result of rendering (520), then proxy server 117 moves on to removing the page view field (425).

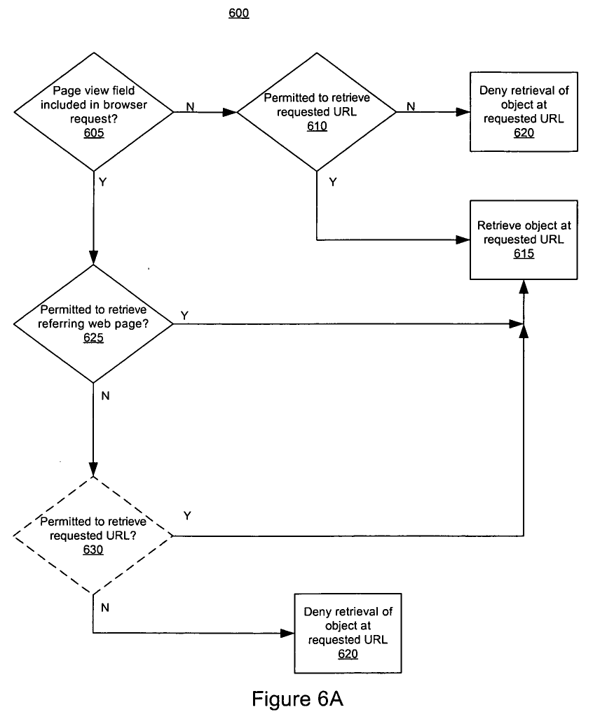

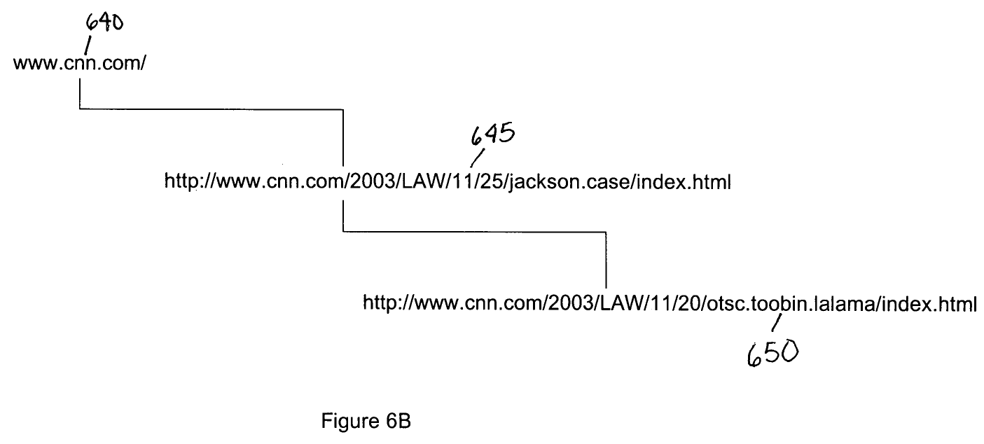

Another implementation (an example of which is described with respect to FIGS. 6A and 6B) involves allowing parentally controlled accounts to access lower level web pages of web pages the account has been given permission to access. As part of a parental control service, an ISP may block particular web pages from being visited by parentally controlled accounts. The ISP may give the user of the parentally controlled account (typically a child or young teen) the ability to request from the parents that certain web pages be unlocked, i.e., that the parentally controlled account be granted permission to view the otherwise blocked web pages.

Proxy server 117 may be used to provide the blocking service. Specifically, proxy server 117 may receive an HTTP request and compare the requested URL to a list of blocked URLs for the parentally controlled account. When parents grant permission to visit a certain web page, the web page is removed from the list of blocked sites. Alternatively, a list of excluded sites may be kept for parentally controlled accounts generally, and each parentally controlled account may have a specific list of web pages for which permission has been granted.

At times, a parent may want to grant permission for the account to be able to access a top-level web page and all of the lower level web pages hyperlinked to in the top-level web page. For example, a parent may wish to give the account access to the web page at “www.cnn.com/” and the web pages connected thereto by hyperlinks 226. Yet, it would be burdensome to the parent to indicate every web page that they wish to give permission to visit. At the same time, without the URL for the web page being explicitly designated by the parent, it may be difficult for proxy server 117 to determine if the lower level web pages should be permitted based simply on reviewing the URL for the lower level web page included in the request. That is, if the lower level web pages are typically blocked, it may not be possible for proxy server 117 to determine that they should now be allowed simply by reviewing the URL in the request for the lower level web page. This is particularly the case if the lower level web page does not share the same domain as the top-level web page.

Using the page view field, however, proxy server 117 can determine that the URL for the lower level web page was obtained from a permitted page and, therefore, should be permitted also. Thus, by comparing the URL in the data of the page view request to the list of allowed sites or to the list of excluded sites (depending on the implementation), proxy server 117 can determine whether the object pointed to by the requested URL should be retrieved and forwarded to the client computer.

Referring to FIG. 6A, in one example of such an application, the processing based on the page view header (420) may include determining if a page view field is included in the received request (605). If the page view field is not included in the request, proxy server 117 determines whether the parentally controlled account is permitted to retrieve the item at the requested URL (610). If so, proxy server 117 obtains the item at the requested URL and forwards the item to the client computer (615). Otherwise, proxy server 117 does not obtain the item and may optionally inform client computer that the parentally controlled account is not permitted to access the item (620).

If the page view field is included, a determination is made as to whether the parentally controlled account is permitted to access the item at the URL contained in the data of the page view field (i.e., the referring page) (625). If so, then the item at the requested URL is obtained and forwarded to the client computer (615). If not, proxy server 117 optionally may make a separate determination as to whether the parentally controlled account can access the requested URL (630). This may be useful in situations in which a web page the account does not have permission to access contains a hyperlink to a web page the account does have permission to access. If proxy server 117 determines that the parentally controlled account can retrieve the URL, proxy server 117 obtains the item at the requested URL and forwards the item to the client computer (615). Otherwise, proxy server 117 does not obtain the item and may optionally inform client computer that the parentally controlled account is not permitted to access the item (620).

Optionally, proxy server 117 may store the requested URLs and their relationship among each other and determine from this relationship whether access to the requested URL should be granted. The web pages linked to by a permitted web page may themselves link to other web pages, all of which constitute the same site. Parents may want to give permission to the parentally controlled account to access the entire site. For example, a parentally controlled account may be given permission to visit the cnn.com website. The cnn.com website includes web page 210 and the web pages connected to web page 210 by hyperlinks 226. The web pages connected to web page 210 also may have hyperlinks connecting to other web pages on the cnn.com web site. By storing which URLs are contained in which web pages, at least during the current session, proxy server 117 may appropriately provide access to the lower level web pages.

Referring to FIG. 6B, for example, the web page 210 at URL 640 (www.cnn.com/) contains a hyperlink 226a for the webpage (not shown) at URL 645 (http://www.cnn.com/2003/LAW/11/25/jackson.case/index.html), which contains a hyperlink (not shown) for the web page (not shown) at URL 650 (http://www.cnn.com/2003/LAW/11/20/otsc.toobin.lalama/index.html). If the parents give permission to access the web page at URL 640 and the parentally controlled account accesses the web page at URL 645 via hyperlink 226a, then the data in the page view field will contain URL 640 and, consequently, proxy server 117 will retrieve the web page at URL 645. If the account, however, attempts to access the web page at URL 650 via a hyperlink on the web page at URL 645, then the data in the page view field will contain URL 645, which has not been specifically permitted. Thus, proxy server 117 may not permit access to the web page at URL 650. However, if proxy server 117 stored the information that URL 645 was obtained from the web page at URL 640, and that the web page at URL 640 is permitted, proxy server 117 may permit access to the web page at URL 650 because the parents gave permission for access to the website at cnn.com and the web page at URL 650 is connected to the top-level page of the website cnn.com.

Other applications also may benefit from tracking the relationship among related URLs. For example, the application to reporting visited web pages may track the relationships between related URLs so that only the top-level web page (or web page manually entered) is reported. That is, the web pages whose URLs are obtained from within a web page (whether retrieved as a result of rendering or as a result of the user selecting a hyperlink) may be excluded from the report to the parental account. Alternatively, a pre-selected default or user-designated number of lower level web pages viewed may be reported with the top-level web page.

Alternatively, proxy server 117 may allow a parentally controlled account to access web pages at URLs located on a web page already retrieved, i.e., it is assumed that if the parentally controlled account has permission for a web page, then it has permission for lower level web pages or other objects hyperlinked to the permitted web page. For example, because the web page for URL 645 was already retrieved (because it was determined to be permitted), when the parentally controlled account requests the web page at URL 650 by a hyperlink in the retrieved web page at URL 645, proxy server 117 observes that URL 645 is contained in the data of the page view field and, consequently, obtains the web page at URL 650 because proxy server 117 has already obtained the web page at URL 645.

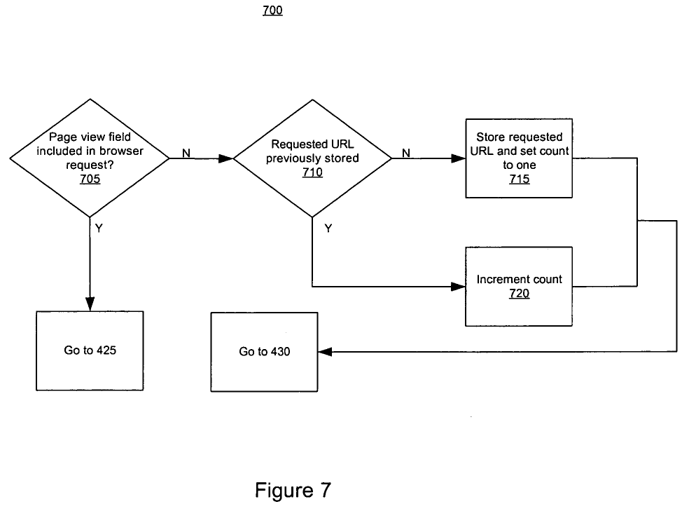

Another application (an example of which is described with respect to FIG. 7) entails accurately tracking popular web pages. Some ISPs provide its members with a list of the web pages that are visited the most by the members of the ISP over a particular period of time. The ISP tracks which web pages are being requested by the members of the ISP, ranks the requested web pages based on the number of requests received in a certain time, and displays a certain number (e.g., 5) of the highest ranking web sites to the users. The ISP tracks the web pages based on the URLs requested by its users. To do so, for example, when client computer 111 sends request 300 for the web page at www.cnn.com/, proxy server 117 stores the URL requested in request 300 (i.e., www.cnn.com/), along with a count of one (assuming client computer 111 is the first computer to request the URL). As other client computers request the URL www.cnn.com/ during a certain period of time, proxy server 117 increments the count accordingly. Proxy server 117 can increment the count for each time the URL is requested, or for each time a unique client computer requests the URL. Proxy server 117 can track whether a particular client computer has previously requested the web page by, for example, noting the IP or other address (or logon information, such as screen name) of the client computers that have requested the web page. After the certain period of time, proxy server 117 ranks the count of the URL www.cnn.com with other URLs requested during that period and displays the top (e.g., 5) requested URLs during the time period.

To accurately track which web pages the ISP's members are actually requesting (and hence, which ones are popular, i.e., requested by the users the most over a certain period of time), it is advantageous for the ISP to distinguish web pages the members request from, e.g., the objects requested when a web page is rendered. For example, when client computer 111 sends request 300 for web page 210, client computer 111 also will send requests 310 and 320 when web page 210 renders. However, tracking the URLs in requests 310 and 320 does not accurately reflect what is popular among the members of the ISP because members of the ISP have not specifically requested these objects themselves, rather they were requested as part of the web page at www.cnn.com/. Thus, to report these URLs as popular may confuse members into thinking the objects (e.g., graphic 212) are what is popular, instead of the web page at www.cnn.com/. Further, when only a particular number of popular web pages are displayed, these objects may be ranked higher than web pages users intentionally requested, thereby preventing web pages that are popular from being displayed to the members.

Referring to FIG. 7, in one example of such an application, the processing based on the page view header (420) may include determining if a page view field is included in the received request (705). If not, the URL is stored (if not previously (710)) and a count is set to one (715). If the URL has been previously stored, the count is incremented by one (720). If proxy server 117 tracks unique requests, then proxy server 117 may determine whether this is a unique request before incrementing the count. Proxy server 117 then moves on to forwarding the request (430).

If a page view field is included in the request, the URL is not stored or the counter associated with the URL is not incremented Proxy server 117 then moves on to removing the page view field (425).

The techniques described above are not limited to any particular hardware or software configuration. Rather, they may be implemented using hardware, software, or a combination of both. The methods and processes described may be implemented as computer programs that are executed on programmable computers comprising at least one processor and at least one data storage system. The programs may be implemented in a high-level programming language and may also be implemented in assembly or other lower level languages, if desired.

Any such program will typically be stored on a computer-usable storage medium or device (e.g., CD-Rom, RAM, or magnetic disk). When read into the processor of the computer and executed, the instructions of the program cause the programmable computer to carry out the various operations described above.

A number of implementations have been described. Nevertheless, it will be understood that various modifications may be made. For example, while the processing based on the page view field has been described as being performed at a proxy server, the processing may be performed at other locations, such as the server computer that includes the requested object. Also, while preventing the reporting of certain URLS has been described as not storing the URLs depending on the page view field, an alternative implementation may include storing the request URLs and the URLs in the page view field, and then filtering the requested URLs by the stored URLs from the page view field such URLs for objects in a web page or other URLs not intentionally requested by the user are not reported. Accordingly, other implementations are within the scope of the following claims.

1. A method for processing a request for a first resource located on a server computer, the method comprising:
receiving the request for the first resource from a client computer, wherein the request indicates a location of the first resource;
determining whether the received request indicates that the location of the first resource was obtained from a second resource rendered at the client computer; and
performing processing related to access controls based on whether the received request indicates that the location of the first resource was obtained from a second resource rendered at the client computer.

2. The method of claim 1 wherein the second resource rendered at the client computer is a document displayed by a browser at the client computer.

3. The method of claim 1 wherein the access controls relate to a parental control service.

4. The method of claim 3 wherein performing processing related to access controls comprises including the location of the first resource in a report to a parental account when the request does not indicate that the location of the first resource was obtained from a second resource rendered at the client computer.

5. The method of claim 3 wherein performing processing related to access controls comprises excluding the location of the first resource from a report to the parental account when the request indicates that the location of the first resource was obtained from a second resource rendered at the client computer.

6. The method of claim 3 wherein the second resource rendered at the client computer is a document displayed by a browser at the client computer and performing processing related to access controls comprises:
when the request indicates that the location of the first resource was obtained from the document displayed by the browser at the client computer, determining whether the location for the first resource was obtained from the document as a result of a user selecting a hyperlink to the first resource included in the document; and
including the location of the first resource in a report to a parental account when the location for the first resource was obtained from the document as a result of the user selecting the hyperlink.

7. The method of claim 3 wherein the second resource rendered at the client computer is a document displayed by a browser at the client computer and performing processing related to access controls comprises:
when the request indicates that the location of the first resource was obtained from the document displayed by the browser at the client computer, determining whether the location for the first resource was obtained from the document as a result of the browser displaying the document; and
excluding the location of the first resource in a report to a parental account when the location for the first resource was obtained from the document as a result of the browser displaying the document.

8. The method of claim 3 wherein the request further indicates a location of the second resource from which the location of the first resource was obtained.

9. The method of claim 8 wherein performing processing related to access controls comprises:
using the location of the second resource to determine if a parentally controlled account is permitted to obtain the second resource; and
providing the first resource to the client computer when the parentally controlled account is permitted to obtain the second resource.

10. The method of claim 1 wherein performing processing related to access controls comprises:
providing the client computer with the first resource when the request indicates that the location of the first resource was obtained from a second resource rendered at the client computer.

11. The method of claim 3 wherein performing processing related to access controls comprises:
when the request does not indicate that the location of the first resource was obtained from a second resource rendered at the client computer, determining whether a parentally controlled account is permitted to obtain the first resource; and
providing the client computer with the first resource when the parentally controlled account is permitted to obtain the first resource.

12. The method of claim 1 wherein:
receiving the request for the first resource comprises receiving the request for the first resource at a proxy server;
determining whether the received request indicates that the location of the first resource was obtained from a second resource rendered at the client computer comprises determining whether the received request indicates that the location of the first resource was obtained from a second resource rendered at the client computer at the proxy server; and
performing processing related to access controls comprises performing processing related to access controls at a proxy server.

13. The method of claim 12 further comprising:
modifying the request by removing the indication that the location of the first resource was obtained from a second resource rendered at the client computer;
sending the modified request to the server computer;
receiving a response from the server computer; and
forwarding the response to the client computer.

14. A method for processing a request for a first resource located on a server computer, the method comprising:
receiving the request for the first resource from a client computer, wherein the request indicates a location of the first resource;
determining whether the received request indicates that the location of the first resource was obtained from a second resource rendered at the client computer; and
performing processing related to accurately tracking frequently requested resources based on whether the received request indicates that the location of the first resource was obtained from a second resource rendered at the client computer.

15. The method of claim 14 wherein the second resource rendered at the client computer is a document displayed by a browser at the client computer.

16. The method of claim 14 wherein performing processing related to accurately tracking frequently requested resources comprises incrementing a count associated with the first resource when the request does not indicate that the location of the first resource was obtained from a second resource rendered at the client computer.

17. The method of claim 16 further comprising:
ranking the first resource with other requested resources based on the count;
selecting a defined number of resources that are highly ranked; and
providing the location of the selected resources to the client computer such that the browser can display a document that includes hyperlinks to the selected resources.

18. The method of claim 14 wherein performing processing related to accurately tracking frequently requested resources comprises:
when the request does not indicate that the location of the first resource was obtained from a second resource rendered at the client computer, determining if the location of the first resource has been stored previously;
when the location of the resource has not been stored previously, storing the location of the resource; and
associating a count with the stored location.

19. A method for processing a request for a resource located on a server computer, the method comprising:
receiving the request for the resource from a client computer, wherein the request indicates a location of the resource;
determining whether a field in the received request indicates the location of the first resource was obtained from a document displayed by a browser at the client computer;
generating a list that contains locations of resources requested by the browser at the client computer; and
excluding the location of the resource from the list when a field in the received request indicates the location of the first resource was obtained from a document displayed by a browser at the client computer.

20. A computer-usable medium having a computer program embodied thereon for processing a request for a first resource located on a server computer, the computer program comprising instructions for causing a computer to perform the following operations:
receive the request for the first resource from a client computer, wherein the request indicates a location of the first resource;
determine whether the received request indicates that the location of the first resource was obtained from a second resource rendered at the client computer; and
perform processing related to access controls based on whether the received request indicates that the location of the first resource was obtained from a second resource rendered at the client computer.

21. The medium of claim 20 wherein the second resource rendered at the client computer is a document displayed by a browser at the client computer.

22. The medium of claim 20 wherein the access controls relate to a parental control service.

23. The medium of claim 22 wherein, to perform processing related to access controls, the computer program further comprises instructions for causing a computer to include the location of the first resource in a report to a parental account when the request does not indicate that the location of the first resource was obtained from a second resource rendered at the client computer.

24. The medium of claim 22 wherein, to perform processing related to access controls, the computer program further comprises instructions for causing a computer to exclude the location of the first resource from a report to the parental account when the request indicates that the location of the first resource was obtained from a second resource rendered at the client computer.

25. The medium of claim 22 wherein the second resource rendered at the client computer is a document displayed by a browser at the client computer and, to perform processing related to access controls, the computer program further comprises instructions for causing a computer to:
when the request indicates that the location of the first resource was obtained from the document displayed by the browser at the client computer, determine whether the location for the first resource was obtained from the document as a result of a user selecting a hyperlink to the first resource included in the document; and
include the location of the first resource in a report to a parental account when the location for the first resource was obtained from the document as a result of the user selecting the hyperlink.

26. The medium of claim 22 wherein the second resource rendered at the client computer is a document displayed by a browser at the client computer and, to perform processing related to access controls, the computer program further comprises instructions for causing a computer to:
when the request indicates that the location of the first resource was obtained from the document displayed by the browser at the client computer, determine whether the location for the first resource was obtained from the document as a result of the browser displaying the document; and
exclude the location of the first resource in a report to a parental account when the location for the first resource was obtained from the document as a result of the browser displaying the document.

27. The medium of claim 22 wherein the request further indicates a location of the second resource from which the location of the first resource was obtained.

28. The medium of claim 27 wherein, to perform processing related to access controls, the computer program further comprises instructions for causing a computer to:
use the location of the second resource to determine if a parentally controlled account is permitted to obtain the second resource; and
provide the first resource to the client computer when the parentally controlled account is permitted to obtain the second resource.

29. The medium of claim 20 wherein, to perform processing related to access controls, the computer program further comprises instructions for causing a computer to:
provide the client computer with the first resource when the request indicates that the location of the first resource was obtained from a second resource rendered at the client computer.

30. The medium of claim 22 wherein, to perform processing related to access controls, the computer program further comprises instructions for causing a computer to:
when the request does not indicate that the location of the first resource was obtained from a second resource rendered at the client computer, determine whether a parentally controlled account is permitted to obtain the first resource; and
provide the client computer with the first resource when the parentally controlled account is permitted to obtain the first resource.

31. The medium of claim 20 wherein:
to receive the request for the first resource the computer program further comprises instructions for causing a computer to receive the request for the first resource at a proxy server;
to determine whether the received request indicates that the location of the first resource was obtained from a second resource rendered at the client computer the computer program further comprises instructions for causing a computer to determine whether the received request indicates that the location of the first resource was obtained from a second resource rendered at the client computer at the proxy server; and
to perform processing related to access controls the computer program further comprises instructions for causing a computer to perform processing related to access controls at a proxy server.

32. The medium of claim 31 wherein the computer program further comprises instructions for causing a computer to
modify the request by removing the indication that the location of the first resource was obtained from a second resource rendered at the client computer;
send the modified request to the server computer;
receive a response from the server computer; and
forward the response to the client computer.

33. A computer-usable medium having a computer program embodied thereon for processing a request for a first resource located on a server computer, the computer program comprising instructions for causing a computer to perform the following operations:
receive the request for the first resource from a client computer, wherein the request indicates a location of the first resource;
determine whether the received request indicates that the location of the first resource was obtained from a second resource rendered at the client computer; and
perform processing related to accurately tracking frequently requested resources based on whether the received request indicates that the location of the first resource was obtained from a second resource rendered at the client computer.

34. The medium of claim 33 wherein the second resource rendered at the client computer is a document displayed by a browser at the client computer.

35. The medium of claim 33 wherein, to perform processing related to accurately tracking frequently requested resources, the computer program further comprises instructions for causing a computer to increment a count associated with the first resource when the request does not indicate that the location of the first resource was obtained from a second resource rendered at the client computer.

36. The medium of claim 35 wherein the computer program further comprises instructions for causing a computer to:
rank the first resource with other requested resources based on the count;
select a defined number of resources that are highly ranked; and
provide the location of the selected resources to the client computer such that the browser can display a document that includes hyperlinks to the selected resources.

37. The medium of claim 33 wherein, to perform processing related to accurately tracking frequently requested resources, the computer program further comprises instructions for causing a computer to:
when the request does not indicate that the location of the first resource was obtained from a second resource rendered at the client computer, determine if the location of the first resource has been stored previously;
when the location of the resource has not been stored previously, store the location of the resource; and
associate a count with the stored location.

38. A computer-usable medium having a computer program embodied thereon for processing a request for a resource located on a server computer, the computer program comprising instructions for causing a computer to perform the following operations:
receive the request for the resource from a client computer, wherein the request indicates a location of the resource;
determine whether a field in the received request indicates the location of the first resource was obtained from a document displayed by a browser at the client computer;
generate a list that contains locations of resources requested by the browser at the client computer; and
exclude the location of the resource from the list when a field in the received request indicates the location of the first resource was obtained from a document displayed by a browser at the client computer.

39. An apparatus for processing a request for a first resource located on a server computer, the method comprising:
means for receiving the request for the first resource from a client computer, wherein the request indicates a location of the first resource;
means for determining whether the received request indicates that the location of the first resource was obtained from a second resource rendered at the client computer; and
means for performing processing related to access controls based on whether the received request indicates that the location of the first resource was obtained from a second resource rendered at the client computer.

40. An apparatus for processing a request for a first resource located on a server computer, the method comprising:
means for receiving the request for the first resource from a client computer, wherein the request indicates a location of the first resource;
means for determining whether the received request indicates that the location of the first resource was obtained from a second resource rendered at the client computer; and
means for performing processing related to accurately tracking frequently requested resources based on whether the received request indicates that the location of the first resource was obtained from a second resource rendered at the client computer.

41. An apparatus for processing a request for a resource located on a server computer, the method comprising:
means for receiving the request for the resource from a client computer, wherein the request indicates a location of the resource;
means for determining whether a field in the received request indicates the location of the first resource was obtained from a document displayed by a browser at the client computer;
means for generating a list that contains locations of resources requested by the browser at the client computer; and
means for excluding the location of the resource from the list when a field in the received request indicates the location of the first resource was obtained from a document displayed by a browser at the client computer.
